(19) United States
(12) Patent Application Publication
(10) Pub. No.: US 2006/0037933 A1
(43) Pub. Date: Feb. 23, 2006

(54) Mirror process using tungsten passivation layer for preventing metal-spiking induced mirror bridging and improving mirror curvature

(76) Inventors: Wei-Ya Wang, Chiayi (TW); Chung-Yuan Cheng, Hsinchu (TW); Tzu-Yang Wu, Hsinchu (TW); Keven Hung, Taipei (TW); Fei-Yuh Chen, Hsinchu (TW)

Correspondence Address: BIRCH STEWART KOLASCH & BIRCH, PO BOX 747, FALLS CHURCH, VA, 22040-0747, US

(21) Appl. No.: 10/923,026

(22) Filed: Aug. 23, 2004

(51) Int. Cl. C23F 1/00; B44C 1/22

(52) U.S. Cl. 216/2; 216/37; 216/58; 216/79

(57) ABSTRACT

A mirror process uses a tungsten passivation layer to prevent metal-spiking induced mirror bridging and improve mirror curvature. A mirror structure is patterned on a first sacrificial layer overlying a substrate. A tungsten passivation layer is then blanket deposited to cover the top and sidewalls of the mirror structure. A second sacrificial layer is formed overlying the tungsten passivation layer. A releasing process with an etchant including XeF₂ is performed to remove the second sacrificial layer, the tungsten passivation layer and the first sacrificial layer simultaneously.

### FIELD OF THE INVENTION

The present invention relates to microelectromechanical system (MEMS) mirror technologies, and particularly to a mirror process using a tungsten passivation layer for preventing spiking-induced mirror bridging and improving mirror curvature.

### BACKGROUND OF THE INVENTION

Microelectromechanical system (MEMS) devices are of increasing commercial interest and importance for use in a variety of applications, such as sensors, accelerometers, electrical switches, optical switches, microlenses, capacitors, inductors, and micromirrors for direct view and projection displays. An emerging projection display technology called Digital Light Processing (DLP) accepts digital video and transmits to the eye a burst of digital light pulses that the eye interprets as a color analog image. DLP is based on a MEMS device known as the Digital Micromirror Device (DMD). The DMD is a fast reflective digital light switch, which combines with image processing, memory, a light source and optics to form a DLP system. Typically, electrostatically controlled MEMS mirror structures are used in the light switch to digitally modulate light, thus producing high-quality imagery on screen.

The MEMS mirror structures are fabricated using materials and processes similar to those employed in integrated circuit fabrication. Currently available sub-micron silicon CMOS (complementary metal-oxide-semiconductor) technologies and micro-machining techniques are integrated to create an array of individually addressable mirror structures, and each mirror structure can reflect light in one of two directions depending on the state of an underlying memory cell. In conventional mirror processing, a sacrificial layer of amorphous silicon is formed between a substrate and a reflective film of aluminum alloy, and the sacrificial layer is subsequently released to complete a cantilever-type MEMS structure. Annealing effects on an interface between aluminum alloy and amorphous silicon, however, causes metal spiking when aluminum diffuses into silicon, shorting out the semiconductor device. M. Shahidul Haque, H. A. Naseem, and W. D. Brown, “Interaction of aluminum with hydrogenated amorphous silicon at low temperature”, J. Appl. Phys. 75(8), 15 Apr. 1994, is incorporated herein by reference.

In order to solve the metal spiking problem, a barrier layer is added on the aluminum mirror film to block aluminum metal from spiking out and reacting with other surfaces, such as silicon. For example, two barrier oxide films are respectively added on the top and the bottom of the aluminum mirror film. Unfortunately, a sidewall-spiking problem still occurs because aluminum diffuses into subsequent interfacing silicon through the patterned sidewalls of the aluminum mirror film. This accompanying sidewall-spiking problem also results in a mirror bridging phenomenon. In an effort to address the shortcomings of aluminum-silicon contacts, more elaborate mirror structures employ oxide spacers to cover the sidewalls of the aluminum mirror films. The oxide spacer process, however, is difficult to control an etching termination, which may lead to an undesirable mirror curvature or a mirror-coupling problem. For example, in an under-etching case, oxide residues are produced to couple the discrete mirror structures together, resulting in a mirror malfunction. Alternatively, in an over-etching case, the top barrier layer over the aluminum mirror film is attacked to become thinner than the bottom barrier layer below the aluminum mirror film. Variation in the thickness of the top barrier layer causes unequal stresses between the frontside and backside of the aluminum mirror film, and such mirror structure exhibits a change in its geometrical form, e.g., bow, twist, etc. The bending form will worsen mirror curvature and thereby significantly influences mirror reflectivity.

The challenges in the field of MEMS mirror structures have continued to increase with demands for more and better techniques having greater effectiveness. Therefore, a need has arisen for a new method for preventing a mirror-bridging phenomenon and improving mirror curvature.

### SUMMARY OF THE INVENTION

It is an object of the present invention to provide a mirror process using a tungsten passivation layer to prevent metal-spiking induced mirror bridging and improve mirror curvature.

It is another object of the present invention to provide a mirror process using a blanket deposition of a tungsten passivation layer to overcome the problems of the prior art through the use of an oxide spacer process.

To achieve the above objectives, the present invention, the present invention provides a mirror process as follows. A mirror structure is patterned on a first sacrificial layer overlying a substrate. A tungsten passivation layer is then blanket deposited to cover the top and sidewalls of the mirror structure. A second sacrificial layer is formed overlying the tungsten passivation layer. A releasing process with an etchant including XeF₂ is performed to remove the second sacrificial layer, the tungsten passivation layer and the first sacrificial layer simultaneously.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIGS. 1 to 5 are cross-sectional views of manufacturing a mirror structure in various stages in accordance with the present invention; and

FIG. 6 is a process flow diagram of the present invention.

### DETAILED DESCRIPTION OF PREFERRED EMBODIMENTS

The present invention provides a mirror process using a tungsten passivation layer to prevent metal-spiking induced mirror bridging and improve mirror curvature. Particularly, the present invention uses a blanket deposition for the tungsten passivation layer to overcome the aforementioned problems of the prior art through the use of an anisotropic dry etch step in an oxide spacer process. The inventive mirror process has wide applicability to various light-reflecting mirror systems, since the stability of mirror curvature is essential for reliable operation of most of the MEMS-based optical devices. Examples of such devices include light switches, optical modulators, optical attenuators, signal attenuators, and the like. A wide variety of MEMS mirror devices can be made in accordance with the methods and materials of the present invention.

Hereinafter, reference will now be made in detail to the present preferred embodiments of the invention, examples of which are illustrated in the accompanying drawings. Wherever possible, the same reference numbers are used in the drawings and the description to refer to the same or like parts. In the drawings, the shape and thickness of an embodiment may be exaggerated for clarity and convenience. This description will be directed in particular to elements forming part of, or cooperating more directly with, apparatus in accordance with the present invention. It is to be understood that elements not specifically shown or described may take various forms well known to those skilled in the art. Further, when a layer is referred to as being on another layer or “on” a substrate, it may be directly on the other layer or on the substrate, or intervening layers may also be presented.

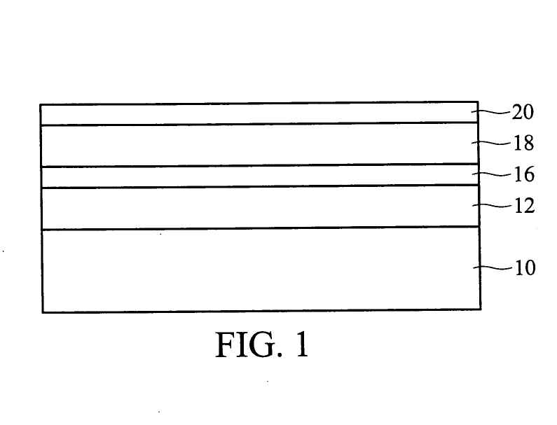

FIGS. 1 to 5 are cross-sectional views of manufacturing a mirror structure in various stages in accordance with the present invention.

Referring to FIG. 1, a substrate 10 is provided with a first sacrificial layer 12, a first barrier layer 16, a reflective layer 18 and a second barrier layer 20 successively deposited thereon. The substrate 10 may be any suitable substrate, such as a light transmissive substrate (e.g. glass, sapphire or quartz substrate), a semiconductor circuit substrate (e.g. a silicon substrate with MOS circuitry thereon), or any of various other substrates commonly used in the semiconductor manufacturing industry. In an embodiment, an optically transmissive substrate is for the use of the mirror array fabrication and then will be bonded with another semiconductor substrate containing electronic circuitry for actuating the mirror structures.

The first sacrificial layer 12 may include, but not limited to, amorphous silicon, silicon-containing materials, and other suitable material of a large etching selectivity ratio between the material being etched and the sacrificial material. In the context, the term “sacrificial layer” as used herein means any layer or portion thereof of any surface micro-machined microstructure that is used to fabricate the microstructure, but which does not exist in the final configuration. The first sacrificial layer 12, referred to as a releasable layer, will be removed after a mirror structure is eventually completed and anchored to the substrate 10 as will be described in subsequent processes. The first sacrificial layer 12, also referred to as a sustainable layer, is to support mirror structures being formed above it during deposition and etching processes. In an embodiment, the first sacrificial layer 12 is an amorphous silicon layer prepared by a PECVD system, and this PECVD system has an advantage of being performed under a low temperature (150° C.˜300° C.). In other exemplary embodiments, materials used to form first sacrificial layer 12 may include a silicon-containing material (e.g., undoped silicon dioxide, undoped silicon oxide, doped silicon dioxide and doped silicon oxide) or an organic material (e.g., photoresist and polymer).

The first barrier layer 16 may include, but not limited to, a transparent dielectric layer, an oxide-containing layer or a nitride-containing layer, through any of a variety of deposition techniques including LPCVD (low-pressure chemical vapor deposition), APCVD (atmospheric-pressure chemical vapor deposition), PECVD (plasma-enhanced chemical vapor deposition), PVD (physical vapor deposition or sputtering) and future-developed deposition procedures. In exemplary embodiments, materials used to form the first barrier layer 16 may include silicon oxide, silicon nitride, silicon oxynitride, titanium nitride (TiN), tantalum nitride (TaN), tungsten nitride (WN), or combinations thereof. One purpose of providing the first barrier layer 16 is to prevent diffusion and spiking of conductive materials through interfacing layers, which can cause undesired short circuits among devices and mirrors. Herein, the first barrier layer 16 can prevent metal spiking from annealing effects on an interface between the reflective layer 18 and the underlying silicon. The first barrier layer 16 may be obtained at a thickness from about 200 angstroms to about 500 angstroms.

The reflective layer 18 may include, but not limited to, aluminum, aluminum alloy, aluminum-silicon-copper, gold, or other suitable conductive materials through PVD techniques. In an exemplary embodiment, the reflective layer 18 is an aluminum-based conductive layer and has a thickness of from about 1500 angstroms to about 10000 angstroms.

The second barrier layer 20 may include, but not limited to, for example a non-transparent dielectric layer, a transparent dielectric layer, an oxide-containing layer or a nitride-containing layer through any of a variety of deposition techniques, including, LPCVD, APCVD, PECVD, PVD and future-developed deposition procedures. The material used to form the second barrier layer 20 may include, for example silicon oxide, silicon nitride, silicon oxynitride, titanium nitride (TiN), tantalum nitride (TaN), tungsten nitride (WN), or combinations thereof. One purpose of providing the second barrier layer 20 is to prevent diffusion and spiking of conductive materials through adjacent insulating layers, which can cause undesired short circuits among devices and mirrors. Herein, the second barrier layer 20 can prevent annealing effects on an interface between the reflective layer 18 and a subsequently interfacing silicon material. The second barrier layer 20 may be obtained at a thickness from about 200 angstroms to about 500 angstroms. In an embodiment, the thickness of the second barrier layer 20 is substantially equal to that of the first barrier layer 16.

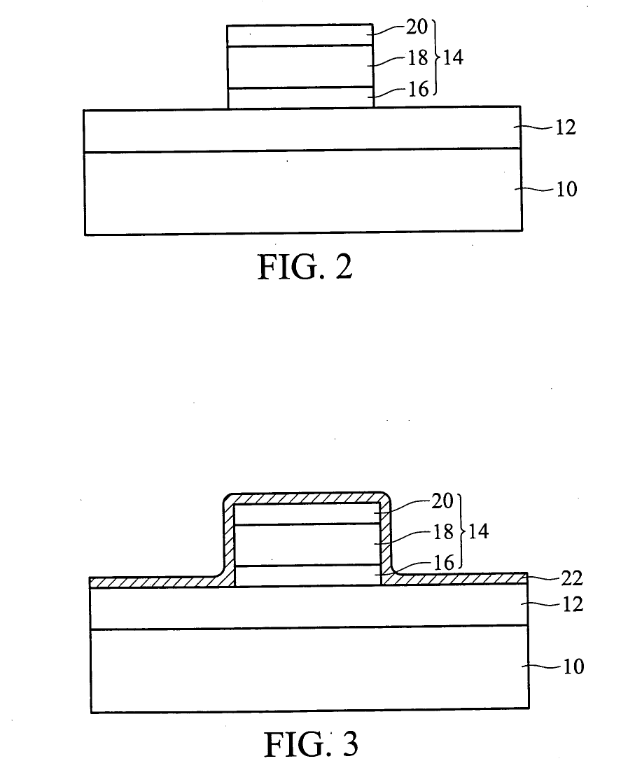

Advanced technologies including lithography and masking technologies and dry etching such as RIE (Reactive Ion Etching) and other plasma etching processes, are employed to define the mirror laminate including the layers 16, 18 and 20 as an individual mirror structure 14 as shown in FIG. 2. It should be appreciated that the individual mirror structure 14 is part of a mirror array. A wide variety of mirror shapes may be patterned at this stage. For simplicity, other mirror structures of the mirror array are not shown in FIG. 2. One or more dielectric films that act as a reflective coating may be deposited on the mirror structure 14 to enhance mirror reflectivity. This stage substantially keeps the thickness uniformity of the first barrier layer 16 and the second barrier layer 20 to achieve an equal stress between the frontside and backside of the reflective film 18.

In FIG. 3, a tungsten passivation layer 22 is then conformally deposited on the first sacrificial layer 12 and the mirror structure 14. In detail, the tungsten passivation layer 22 conformally covers the sidewalls and top of the mirror structure 14 so as to prevent metal spiking into adjacent silicon-containing regions through the exposed sidewalls of the reflective layer 18. The tungsten passivation layer 22 is blanket deposited via a suitable deposition technique, such as physical vapor deposition, chemical vapor deposition electroless plating or electroplating. The tungsten passivation layer 22 has a thickness from about 400 angstroms to about 6000 angstroms. One key feature of the present invention is to cover the exposed sidewalls of the reflective layer 18 with the tungsten passivation layer 22 so as to prevent the metal-spiking induced mirror bridging phenomenon. Another key feature of the present invention is to employ a blanket deposition for the tungsten passivation layer 22 without performing an etch back process (e.g., anisotropic dry etch) on the tungsten passivation layer 22 so as to avoid damages to the second barrier layer 20, thus the thickness uniformity of the barrier layers 16 and 20 is maintained and the desirable mirror curvature is also obtained.

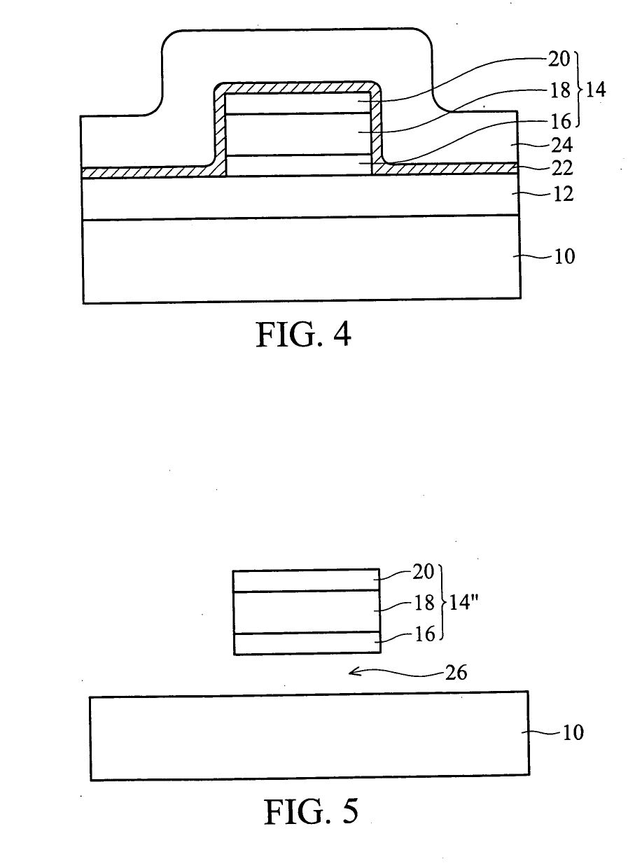

Next, in FIG. 4, a second sacrificial layer 24 is deposited on the tungsten passivation layer 22 for the purpose of forming a gap portion or a support structure (e.g., a hinge structure) at the time of releasing the mirror structure 14. The second sacrificial layer 24 is deposited at a thickness from about 5000 angstroms to about 15000 angstroms through PECVD, APCVD or LPCVD processes. The second sacrificial layer 24 may include, but not limited to, amorphous silicon, silicon-containing materials, and other suitable material of a large etching selectivity ratio between the material being etched and the sacrificial material. The second sacrificial layer 24 will be removed in the same stage of removing the first sacrificial layer 12 to release the mirror structure 14. In an embodiment, the second sacrificial layer 24 is an amorphous silicon layer prepared by a PECVD system, and this PECVD system has an advantage of being performed under a low temperature (150° C.˜300° C.). The metal spiking phenomenon (e.g. aluminum diffusing into amorphous silicon) can be eliminated to prevent a mirror bridging problem as a result of the tungsten passivation layer 22 formed on the sidewalls of the reflective layer 18.

After fabricating the support elements (for example hinge structures) to anchor the mirror structure 14 to substrate 10, a releasing process is performed to complete a cantilever-type mirror structure 14″ as shown in FIG. 5. For simplicity, the support elements are not shown in FIG. 5 to avoid obscuring aspects of the present embodiment. A release process such as a selective etch process, is performed to remove the first sacrificial layer 12, the second sacrificial layer 24 and the tungsten passivation layer 22, thus the mirror structure 14″ is free standing on the substrate 10 through a gap 26 produced there between. The release process substantially does not damage the mirror structure 14, and leaves the second barrier layer 20 substantially intact. If both sacrificial layers 12 and 24 are formed of the same material, these two layers 12 and 24 can be removed at the same time with the tungsten passivation layer 22. If both sacrificial layers 12 and 24 are formed of different materials, the two layers can be removed with different removal chemistry consecutively. Of course, the etchant or chemical used is selected so as to selectively remove the sacrificial layers 12 and 24 without appreciably removing mirror structure 14. In a preferred embodiment, both sacrificial layers 12 and 24 are formed of amorphous silicon, and the release process uses an etchant including xenon difluoride (XeF₂), and the other vapor phase spontaneous chemical etchants to selectively etch amorphous silicon and the tungsten passivation layer 22 simultaneously. The selective etch process may comprise additional gas components such as N₂ or an inert gas (Ar, Xe, He, etc.). The resulting cantilever-type mirror structure 14″ is similar to the mirror structure 14, and is ready to be integrated with a semiconductor substrate having electrodes and electronic circuitry therein to form a light switch device.

Accordingly, a mirror fabrication using a tungsten passivation layer has been presented that allows and achieves the following advantages. The tungsten passivation layer formed on the exposed sidewalls of the mirror structure can prevent metal spiking into the adjacent amorphous silicon regions, eliminating metal-spiking induced mirror bridging. The formation of the tungsten passivation layer omits an etch back step required in the conventional oxide spacer process can leave the top barrier layer and the bottom barrier layer intact and keep the thickness uniformity of the two barrier layers, thus the desirable mirror curvature is also obtained. Moreover, the tungsten passivation layer is compatible with the releasing process because amorphous silicon and tungsten can be simultaneously removed with an identical etchant, such as XeF₂. Therefore, the inventive mirror process is simple and reliable, and has low process costs and high productivity. The inventive methods and structures can be applied to not only MEMS micro-mirror structures but also a variety of non-MEMS devices. Any light-reflecting system comprising a mirror or an array of mirrors can obtain an improved mirror curvature by the insertion of the tungsten passivation layer.

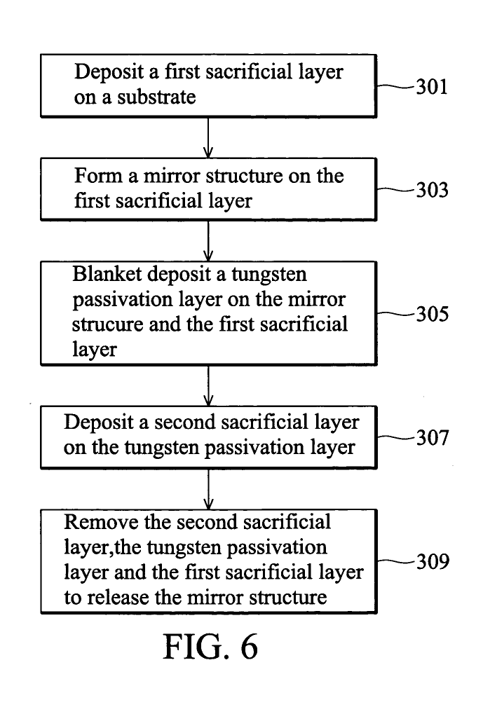

FIG. 6 is a process flow diagram of the present invention. In process 301, a first sacrificial layer is deposited on a substrate. In process 303, a mirror laminate including a first barrier layer, a reflective layer and a second barrier layer, is deposited on the first sacrificial layer, and then the mirror laminate is patterned to define an individual mirror structure. In process 305, a blanket deposition of a tungsten passivation layer is conformally formed on the mirror structure and the first sacrificial layer. The tungsten passivation layer covers the exposed sidewalls of the mirror structure so as to prevent metal spiking into adjacent silicon-containing regions. In process 307, a second sacrificial layer is deposited on the tungsten passivation layer. In process 309, the second sacrificial layer, the tungsten passivation layer and the first sacrificial layer are removed simultaneously to release the mirror structure from the substrate.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

What is claimed is:

1. A mirror process, comprising the steps of:
providing a substrate;
forming a mirror structure overlying said substrate;
blanket depositing a passivation layer overlying said mirror structure and said substrate;
forming a sacrificial layer overlying said passivation layer; and
removing said sacrificial layer and said passivation layer simultaneously.

2. The mirror process of claim 1, wherein said passivation layer comprises tungsten.

3. The mirror process of claim 1, wherein said sacrificial layer comprises amorphous silicon.

4. The mirror process of claim 1, wherein the step of removing said sacrificial layer and said passivation layer uses an etchant comprising XeF₂.

5. The mirror process of claim 1, before the step of forming said mirror structure, further comprising:
forming a releasable layer overlying said substrate, wherein said mirror structure is formed overlying said releasable layer.

6. The mirror process of claim 5, wherein the step of removing said sacrificial layer and said passivation layer removes said releasable layer simultaneously.

7. The mirror process of claim 5, wherein said releasable layer comprises amorphous silicon.

8. The mirror process of claim 1, wherein the step of forming said mirror structure comprising:
forming a first barrier layer overlying said substrate;
forming a reflective layer overlying said first barrier layer;
forming a second barrier layer overlying said reflective layer; and
patterning said second barrier layer, said reflective layer and said first barrier layer as said mirror structure.

9. The mirror process of claim 8, wherein the step of blanket depositing said passivation layer forms a conformal liner along the sidewalls and top of said mirror structure.

10. The mirror process of claim 8, wherein said first barrier layer comprises silicon oxide, silicon nitride, titanium nitride, or a combination thereof.

11. The mirror process of claim 8, wherein said second barrier layer comprises silicon oxide, silicon nitride, titanium nitride, or a combination thereof.

12. The mirror process of claim 8, wherein said reflective comprises aluminum, aluminum alloy, aluminum-silicon-copper, aluminum-based materials, or a combination thereof.

13. A mirror process, comprising the steps of:
forming a first sacrificial layer overlying a substrate;
forming a mirror structure overlying said first sacrificial layer, wherein said mirror structure comprises a reflective layer sandwiched between a first barrier layer and a second barrier layer;
forming a tungsten passivation layer overlying said mirror structure and said first sacrificial layer, wherein said tungsten passivation layer is blanket deposited to cover the top and sidewalls of said mirror structure;
forming a second sacrificial layer overlying said tungsten passivation layer; and
removing said second sacrificial layer, said tungsten passivation layer and said first sacrificial layer simultaneously.

14. The mirror process of claim 13, wherein said first sacrificial layer comprises amorphous silicon.

15. The mirror process of claim 13, wherein said second sacrificial layer comprises amorphous silicon.

16. The mirror process of claim 13, wherein the step of removing said second sacrificial layer, said passivation layer and said first sacrificial layer uses an etchant comprising XeF₂.

17. The mirror process of claim 13, wherein said first barrier layer comprises silicon oxide, silicon nitride, titanium nitride, or a combination thereof.

18. The mirror process of claim 13, wherein said second barrier layer comprises silicon oxide, silicon nitride, titanium nitride, or a combination thereof.

19. The mirror process of claim 13, wherein said reflective comprises aluminum, aluminum alloy, aluminum-silicon-copper, aluminum-based materials, or a combination thereof.
